(19) United States
(12) Patent Application Publication
(10) Pub. No.: US 2012/0045944 A1
(43) Pub. Date: Feb. 23, 2012

(54) ELECTRICAL PLUG-AND-SOCKET DEVICE

(75) Inventor: Kurt Standke, Bonn (DE)

(73) Assignee: Rema Lipprandt GMBH & Co. KG, Bonn (DE)

(21) Appl. No.: 13/266,457

(22) PCT Filed: Apr. 29, 2010
(86) PCT No.: PCT/EP10/55779

§ 371 Date: Oct. 27, 2011

(30) Foreign Application Priority Data
Apr. 30, 2009 (DE) 20 2009 004 763.6

(51) Int. Cl. H01R 24/28

(52) U.S. Cl. 439/660

(57) ABSTRACT

An electrical plug apparatus for establishing an electrical connection by mating with a mating plug apparatus includes a housing, an electrical feed line comprising an insulating sheath, and at least one electrical contact element comprising a first end and a second end. The first end is in contact with the electrical feed line. The second end leads in a plugging direction, and is mounted in the housing and configured so as to move perpendicular to the plugging direction under an effect of an electrical mating contact element of the mating plug apparatus bearing against the second end. The at least one electrical contact element comprises a material which allows an elastic deformation movement as an effect of the electrical mating plug element.

### CROSS REFERENCE TO PRIOR APPLICATIONS

This application is a U.S. National Phase application under 35 U.S.C. §371 of International Application No. PCT/EP2010/055779, filed on Apr. 29, 2010 and which claims benefit to German Patent Application No. 20 2009 004 763.6, filed on Apr. 30, 2009. The International Application was published in German on Nov. 4, 2010 as WO 2010/125132 A1 under PCT Article 21(2).

### FIELD

The present invention provides an electrical plug apparatus for establishing an electrical connection by mating with a mating plug apparatus, having a housing, having at least one electrical contact element which has a first end, which is connected to an electrical feed line which comprises an insulating sheath, and a second end, which leads in the plugging direction, and is mounted in the housing and can be moved perpendicular to the plugging direction under the action of an electrical mating contact element of the mating plug apparatus bearing against it.

### BACKGROUND

A plug apparatus of this kind is provided by REMA Lipprandt GmbH & Co. KG, Bonn and is called a “plug apparatus with flat contacts”. The contacts are mounted in a moveable manner within the housing so that the plug apparatus can be mated with and disconnected from the mating plug apparatus. A leaf spring is therefore anchored in the housing for each contact, the contacts being moved against the spring force of said leaf springs in the direction perpendicular to the plugging direction during the plugging process and thereby causing the contacts and mating contacts to interact under the action of a spring force. The ability of the contacts to move in the housing is selected so that the contacts can be mated by means of a raised portion which is directed toward the mating contact. Raised portions of this kind are provided in order to create defined contact areas for the purpose of avoiding electrical contact resistances. If the contact and mating contact each have mutually facing raised portions, a locking force is additionally provided by these raised portions, this locking force having to be overcome when the plug apparatus and mating plug apparatus are disconnected.

Plug apparatuses of this kind have already long been used in a variety of applications. It has been found that the force which must be applied to mate or disconnect the plug apparatus and mating plug apparatus varies greatly and cannot always be reproduced in the case of brand-new plugs. This phenomenon is presumably associated with the fact that this force is dependent on a large number of parameters, for example on:
the mechanical properties of the electrical feed line;
the type of connection between the electrical feed line and the electrical contact element;
the relative position of the feed line with respect to the electrical contact element; and
the degree of wear of the electrical plug apparatus, in particular depending on the age of and the mechanical loading on the plug apparatus.

The movement of the electrical contact elements in the housing leads to wear of the bearing seats and to an increase in play as the duration and extent of loading increases.

It was also surprisingly found in the past that, in individual cases, all plugs of an entire fleet of vehicles were subject to increased wear. This phenomenon is explained by a mating plug, for example a charger mating plug, on account of production and processing tolerances, having electrical contact elements with properties which have a particularly wear-inducing effect. In the past, attempts were made to mitigate this problem by minimizing the processing tolerance by means of special processing tools.

A further disadvantage of plug apparatuses with flat contacts is that a strain relief means which acts on the electrical feed lines reduces the ability of the electrical contact elements to move, as a result of which the mating and disconnection process in plug apparatuses of this kind is made considerably more difficult. If the strain relief means is dispensed with in order to avoid the above disadvantage, this creates particular problems since plug apparatuses of this kind must often be disconnected by pulling the cables: the force required for disconnection purposes then acts virtually directly on the contacts, possibly bending said contacts and the leaf springs which are provided for establishing electrical contact, with the result that reliable electrical contact is no longer ensured. The electrical contact resistances which are produced as a result entail the risk of the plug apparatus being thermally destroyed, in the worst case even catching fire. Contact problems of this kind can also be created by production tolerances of the various components when these unfavorably add up. The shape of the contact can also be negatively changed after the connection socket containing the associated cable is pressed, with the result that processing tolerances can be added to the production tolerances.

### SUMMARY

An aspect of the present invention is is to provide an improved electrical plug apparatus with respect to the abovementioned disadvantages.

In an embodiment, the present invention provides an electrical plug apparatus for establishing an electrical connection by mating with a mating plug apparatus which includes a housing, an electrical feed line comprising an insulating sheath, and at least one electrical contact element comprising a first end and a second end. The first end is in contact with the electrical feed line. The second end leads in a plugging direction, and is mounted in the housing and is configured so as to move perpendicular to the plugging direction under an effect of an electrical mating contact element of the mating plug apparatus bearing against the second end. The at least one electrical contact element comprises a material which allows an elastic deformation movement as an effect of the electrical mating plug element.

### BRIEF DESCRIPTION OF THE DRAWINGS

The present invention is described in greater detail below on the basis of embodiments and of the drawings in which:

FIG. 1 shows a vertical longitudinal section through said plug apparatus along section line I-I in FIG. 2, and

FIG. 2 shows a horizontal longitudinal section along section line II-II in FIG. 1.

### DETAILED DESCRIPTION

In an embodiment of the present invention, in the electrical plug connection, the at least one electrical contact element can, for example, be produced from a material which allows the movement approximately perpendicular to the plugging direction under the action of the electrical mating plug element with elastic deformation.

It has surprisingly been found that it is possible to use electrical contact elements with a high electrical conductivity and good electrical contact properties together with elastic resilience, this enabling mating with mating contact elements without the electrical contact elements having to be mounted in a moveable manner in the housing and without supporting spring elements being required for this purpose. This reduces production tolerances.

Experiments have shown that possible materials include, for example, bronze alloys, copper beryllium alloys or electrolytic copper alloys if they have, for example, been provided with adequate elastic properties due to mechanical influences (cold-forming).

Since it is no longer necessary to moveably mount the electrical contact elements in the housing on account of the elastic deformability of said electrical contact elements, the housing can, for example, have a bearing region in which the electrical contact element is fixedly mounted in the region of the first end.

The ability to produce an electrical plug apparatus according to the present invention is simplified and the reliability of the contact-connection between the electrical contact element and the feed line which is connected to it is improved if, for example, the electrical feed line is welded to the first end of the contact element. This measure produces processing tolerances which are only low compared to pressing.

In an embodiment of the electrical plug apparatus according to the present invention, the bearing region can, for example, be produced by encapsulating the first end region, which is connected to the electrical feed line, with housing material since shaping of a bearing region in the housing is therefore completely dispensed with and the outlay on production is therefore reduced.

The contacts and the electrical feed lines which are welded to the contacts are seated in a particularly solid manner during the molding process when the housing material and the material of the insulating sheath are matched to one another in such a way that a cohesive connection is established between the materials during the molding process. This produces effective strain relief which also allows disconnection of a plug connection, which is established with the aid of this plug apparatus, by pulling the cable, without damaging the plug apparatus. The plug apparatus housing formed in this way is also resistant to fracture and is suitable for sealing off the connection region between the electrical feed line and the electrical contact element in a gas-tight manner.

In order to be match the electrical plug apparatus according to the present invention to different, existing mating plug apparatuses for mating purposes, the plug apparatus according to the present invention can, for example, have a plugging face which is formed by an attachment fastened to the housing. The same arrangement comprising the electrical contact elements with welded-on electrical feed lines and the housing, which arrangement is then provided with the suitable attachment, can therefore always be used for different mating plug apparatuses.

In order to attach the attachment to the housing, the housing and the attachment may comprise latching devices which are compatible with one another.

It is also possible to provide the housing and the attachment with contact faces which interact with one another and allow for a cohesive connection, for example, by adhesive bonding or welding.

In order to improve electrical contact-connection between the electrical contact element and the electrical mating contact element and to provide a force which has to be overcome when disconnecting the plug apparatus and the mating plug apparatus, the electrical contact elements of the plug apparatus according to the present invention also have a raised portion, which is directed toward the mating contact element, in the region of the second end.

In an embodiment of the electrical plug apparatus according to the present invention, the two examples of said plug apparatus can, for example, be mated in a plugging direction which is rotated through 180°. This electrical plug apparatus can therefore act as a mating plug apparatus, in other words form a plug and socket part at the same time.

The plug apparatus, which is designated 100 overall, comprises two electrical contact elements 1, 2 which are produced by cutting a strand of flat material to length and bending it.

The first ends 7, 8, which are illustrated on the right-hand side in the drawing, of the electrical contact elements 1, 2 are each electrically and mechanically connected to an electrical conductor 5, 6 of an electrical feed line 3, 4 by welding. The electrical feed lines 3, 4 have insulating sheaths 9, 10 which have been removed from the electrical conductors 5, 6 over a length L for welding purposes.

The first ends 7, 8 of the electrical contact elements 1, 2, the length L which has been stripped of insulation and a length 1 of the insulating sheaths 9, 10 which follows said length L in the direction of the electrical feed lines 3, 4 are encapsulated with an insulating plastic material in a form-fitting manner to form a housing 11. This plastic material, which forms the housing 11, and the material of the insulating sheaths 9, 10 are matched to one another such that the insulating sheaths 9, 10 additionally form a cohesive connection with the housing 11 over the length 1.

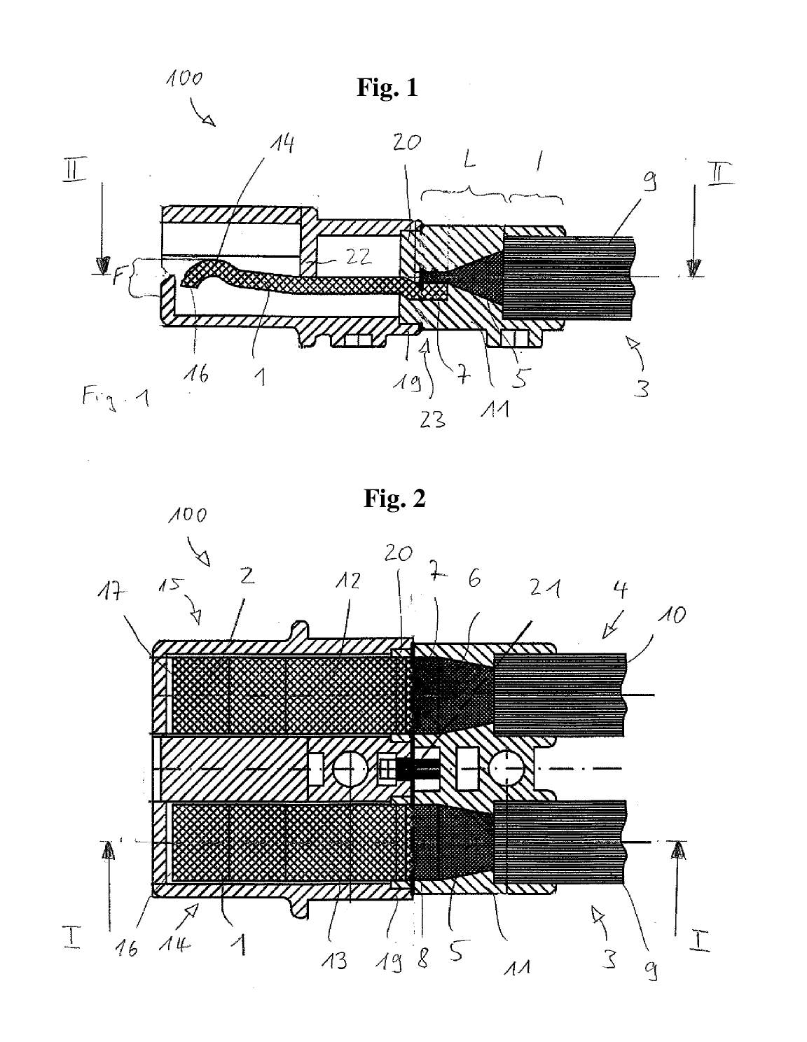

The first ends 7, 8 of the electrical contact elements 1, 2, which first ends are anchored firmly in the housing 11, are adjoined by substantially planar regions 12, 13 which merge with in each case one raised portion 14, 15 which is directed toward a mating contact element (not illustrated in the drawing). The raised portions 14, 15, which form contact areas to the mating contact elements (not illustrated in the drawing), are adjoined by sections which are directed downward according to FIG. 1 and form the second ends 16, 17 of the electrical contact elements 1, 2.

In order for it to be possible for the electrical contact elements 1, 2 to avoid mating contact elements which are present in the mating plug apparatus during mating with a mating plug apparatus (not illustrated in the drawing) and to provide for reliable bearing against the mating contact elements, the electrical contact elements 1, 2 are produced from a highly electrically conductive material which has spring-elastic properties of the kind which allow spring-elastic movement of the raised portions 14, 15 over the length F. Materials which exhibit these properties include, for example, copper alloys such as bronze, copper beryllium or electrolytic copper with a Brinell hardness of >HRW 130.

The electrical plug apparatus 100 also comprises an attachment 18 which completely surrounds the electrical contact elements 1, 2, with the exception of the side which leads in the plugging direction and is illustrated on the left-hand side in the drawing and forms the plugging face of the electrical plug apparatus. The attachment 18 has a collar 19 on the side which faces the housing 11, the contour of said collar being matched to a flange 20 which is provided on the housing 11 in such a way that the collar 19 is seated on the flange 20 at least substantially without play.

The housing 11 and the attachment 18 have compatible latching devices 21 which secure the attachment 18 against being pulled off the housing 11. As an alternative or in addition, the mutually facing surfaces of the collar 19 and of the flange 20 can be connected to one another in a cohesive manner, for example by adhesive bonding, in order to thus establish a more reliable connection between the attachment 18 and the housing 11. By virtue of this measure, various attachments 18, of which the plugging face is matched to the different mating plug apparatuses, can be provided and, if necessary, connected to the arrangement comprising electrical contact elements, the housing and electrical conductors.

In order that the electrical contact elements 1, 2 bear against mating contact elements under a relatively high elastic force in order to increase the reliability of the electrical contact-connection, the attachment 18 has a projection 22 which is directed toward the respective electrical contact element 1, 2 and against which the respective electrical contact element 1, 2 bears, by way of its side which faces the mating contact element, under spring preloading.

The present invention is not limited to embodiments described herein; reference should be had to the appended claims.

### LIST OF REFERENCE NUMBERS

100 Plug apparatus

1 Electrical contact element

2 Electrical contact element

3 Electrical feed line

4 Electrical feed line

5 Electrical conductor

6 Electrical conductor

7 First end

8 First end

9 Insulating sheath

10 Insulating sheath

11 Housing

12 Planar region

13 Planar region

14 Raised portion

1-14. (canceled)

15. An electrical plug apparatus for establishing an electrical connection by mating with a mating plug apparatus, the electrical plug apparatus comprising:
a housing;
an electrical feed line comprising an insulating sheath; and
at least one electrical contact element comprising a first end and a second end, the first end being in contact with the electrical feed line, and the second end leading in a plugging direction and being mounted in the housing and being configured so as to move perpendicular to the plugging direction under an effect of an electrical mating contact element of the mating plug apparatus bearing against the second end,
wherein the at least one electrical contact element comprises a material which allows an elastic deformation movement as an effect of the electrical mating plug element.

16. The electrical plug apparatus as recited in claim 15, wherein the material is a bronze alloy.

17. The electrical plug apparatus as recited in claim 15, wherein the material is a copper beryllium alloy.

18. The electrical plug apparatus as recited in claim 15, wherein the material is an electrolytic copper alloy.

19. The electrical plug apparatus as recited in claim 15, wherein the material is cold-formed.

20. The electrical plug apparatus as recited in claim 15, wherein the housing comprises a bearing region configured to mount the at least one electrical contact element in the housing so as to be fixed in a region of the first end.

21. The electrical plug apparatus as recited in claim 20, wherein the bearing region is provided by molding the first end with a housing material.

22. The electrical plug apparatus as recited in claim 21, wherein the housing material and a material of the insulating sheath are matched so as to provide a cohesive connection between the housing material and the material of the insulating sheath during a molding process.

23. The electrical plug apparatus as recited in claim 15, wherein the electrical feed line is welded to the first end of the at least one electrical contact element.

24. The electrical plug apparatus as recited in claim 15, wherein the electrical plug apparatus comprises a plugging face formed by an attachment attached to the housing.

25. The electrical plug apparatus as recited in claim 24, wherein the housing and the attachment each comprise at least one latching device which are compatible with each another.

26. The electrical plug apparatus as recited in claim 24, wherein the housing and the attachment each comprise at least one contact face configured to interact with each other so as to provide a cohesive connection.

27. The electrical plug apparatus as recited in claim 15, wherein the electrical contact element comprises a raised portion directed toward a mating contact element in a region of the second end.

28. The electrical plug apparatus as recited in claim 15, wherein the electrical plug apparatus and the mating plug apparatus are identical so that two electrical plug apparatuses can be mated in a plugging direction rotated through 180°.
